(19) United States
(12) Patent Application Publication
(10) Pub. No.: US 2009/0246739 A1
(43) Pub. Date: Oct. 1, 2009

(54) Furnace for the thermal treatment of a dental firing object

(75) Inventors: Rudolf Jussel, Feldkrich-Tosters (AT); Jurgen Laubersheimer, Buchs (CH); Christian Werling, Lindau (DE); Christoph Appert, Vaduz (LI)

Correspondence Address: Jonh C. Thompson, 69 Grayton Road, Tonawanda, NY, 14150, US

(73) Assignee: Ivoclar Vivadent AG

(21) Appl. No.: 12/383,173

(22) Filed: Mar. 21, 2009

(30) Foreign Application Priority Data
Mar. 25, 2008 (DE) 10 2008 015 483.0

(51) Int. Cl. A61C 13/00; F27D 19/00; F27D 21/00; B22F 3/10; A61C 5/08

(52) U.S. Cl. 433/223; 219/412; 219/494; 419/1; 432/32

(57) ABSTRACT

A furnace for the thermal treatment of at least one dental firing object, comprising a housing, a firing chamber, a firing chamber base, a heating device, and at least one optical temperature detection element which can be used to detect a temperature in the firing chamber and is intended to enable a contactless temperature measurement of a dental firing object in a simple manner. This is achieved by virtue of the fact that the firing object is mounted on and/or in and/or below and/or alongside a firing aid situated in the firing chamber, and the optical temperature detection element detects the temperature of the firing aid.

### CROSS-REFERENCE TO RELATED APPLICATIONS

This application claims foreign priority benefits under 35 U.S.C. §119(a)-(d) from German patent application ser. no. P 10 2008 015 483.0 filed Mar. 25, 2008.

### TECHNICAL FIELD

The invention relates to a furnace for the thermal treatment of at least one dental firing object, and more particularly to such a furnace including a housing, a firing chamber, a firing chamber base, a heating device and at least one optical temperature detection element which can be used to detect a temperature in the firing chamber.

### BACKGROUND OF THE INVENTION

It is known to use a temperature detection element with an optical sensor in kilns with microwave heating. Said sensor is directed onto an area of the object to be measured that is as planar as possible. In this case, the temperature at the surface of the object is measured.

There are a number of problems, however, when a kiln of this type is used for the thermal treatment of dental restorations.

One difficulty consists in the fact that dental restorations do not have any planar surfaces. This makes a temperature measurement difficult.

A measurement is also problematic in the case of a plurality of dental restorations. This is because if a plurality of dental restorations are situated within the kiln, it is additionally unclear whether the sensor of the temperature detection element is to be oriented toward the dental restoration situated in the center of the firing chamber or the one situated in the edge region of the firing chamber.

Moreover, it is possible for the sensor to be oriented toward individual dental restorations only to a limited extent. The sensor can detect radiation only through a hole in the firing chamber. The detection angle is therefore very limited. The sensor can in practice only look at a dental restoration part in a limited manner. An orientation of the dental restoration within the firing chamber relative to the sensor of the temperature detection element is not possible, therefore, since the view through the hole in the firing chamber is obstructed by the temperature detection element.

U.S. Pat. No. 5,628,564 discloses a method for contactless temperature measurement with an optical sensor. The sensor is embodied as a pyrometer and serves for detecting the temperature of semiconductor wafers in a rapid heating chamber.

U.S. Pat. No. 6,095,682 describes a multimeter that serves for determining the temperature of a surface by means of a contactless measurement of the radiation detected at a distance from the surface.

US 2001/0006174 A1 discloses a method for producing ceramic bodies with the aid of a hybrid furnace with microwaves and infrared radiation. Touch sensors are used to measure a core and surface temperature of the ceramic body to be measured.

DE-B 1 498 822 presents a measurement insert for a furnace, which forms a comparison piece. Two chambers are used in this case, one chamber being present for receiving a test piece and another chamber being present for receiving the comparison piece. The measurement is effected by means of a low-resistance thermistor element. The furnace is part of a device for differential thermal analysis.

Furthermore, DE-B 16 48 905 discloses a method and an apparatus for thermally examining and influencing the state of biological tissues. In this case, use is made of test pieces introduced into a substrate in the form of heating capsules. They are heated on account of inductive heating.

### OBJECTS AND SUMMARY OF THE INVENTION

The invention is based on the object of providing a furnace which enables a contactless temperature measurement of a dental firing object in a simple manner.

It is particularly expedient if the firing object is mounted on and/or in and/or below and/or alongside a firing aid situated in the firing chamber, and the optical temperature detection element detects the temperature of the firing aid.

A firing aid is used according to the invention. It interacts with the sensor of the temperature detection element. The firing aid can be situated below and/or laterally with respect to the dental restoration that is to be subjected to thermal treatment.

The invention makes it possible to use dental restorations that do not have any planar surfaces. The temperature measurement is nevertheless made possible by the aid according to the invention.

It is no problem if a plurality of dental restorations are present simultaneously during the measurement. Since the sensor can be oriented toward the aid, a measurement is possible without any difficulties.

The sensor can detect radiation from the aid through a hole in the firing chamber in a simple manner. The limited detection angle is non critical.

The furnace according to the invention permits a temperature detection method in which a special body or an additional body, which can be formed from balls or powder, for example, is predetermined in a defined manner and its temperature is measured instead of the temperature of the firing object. The temperature is measured contactlessly.

In one advantageous development of the safety device according to the invention it is provided that the firing aid has a thermal and/or electrical and/or dielectric property comparable with the firing object. If the firing aid has thermal and/or electrical and/or dielectric properties comparable with a dental restoration part, the aid can assume the same temperature as the dental restoration part or parts. A very accurate temperature measurement is possible as a result.

It is advantageous if the firing aid is embodied in the form of balls and/or granules and/or a parallelepiped and/or a plate and/or a powder. These forms can firstly be realized easily, and secondly they absorb radiation very rapidly, whereby temperature changes are detected without any time delay. The firing aid can be embodied in plate or parallelepiped form and in the form of granules or a powder.

The firing aid formed from balls, granules or powder is arranged for example in an open tank. The dental restoration part can bear on the firing aid or be at least partially or wholly embedded in said firing aid.

The firing aid is preferably embodied in at least two layers. Its properties can thereby be adapted to the requirements in wider ranges. By way of example, the firing aid can have almost the same thermal properties as the firing object, or it can also be used as necessary for additional heat insulation.

In order that a thermal insulation of the furnace is not impaired by the sensor, in a further advantageous development of the invention a transparent disc is arranged between the firing object or the firing aid and the optical temperature detection element. The disc is expediently arranged on a top side and/or side wall of the firing chamber and/or on the firing chamber base.

It is additionally expedient for the optical temperature detection element to be situated on the top side and/or side wall of the firing chamber and/or on the firing chamber base, such that the sensor is thermally insulated by the disc.

Open-loop or closed-loop temperature control of the furnace can be effected in a simple manner by virtue of the optical temperature detection element being connected to a control unit of the furnace. The temperature control can be effected in the simplest case by means of a two-point control or alternatively by other temperature control.

It has proved to be highly advantageous for the optical temperature detection element to be formed by a pyrometer. In combination with the firing aid, the pyrometer is optimal on account of its measurement spot property. Therefore, at least one part of the firing aid and/or at least one part of the firing object is situated within the entire measurement spot of the pyrometer.

It is possible to use a conventional gas or electrical heating system. It is particularly expedient, however, if the heating device is a conductive heating system or a microwave heating system. The contactless sensor obviates connecting lines within the actual furnace space, which cause inductive currents and in practice would make it impossible to carry out a measurement with conventional resistance elements.

According to one advantageous configuration of the furnace according to the invention, its firing chamber is vertically displaceable and/or pivotable relative to the fixedly arranged firing chamber base. This makes it easier to align the sensor with the firing aid. It is also possible for the firing chamber base to be vertically displaceable relative to the fixedly arranged firing chamber.

In accordance with one advantageous configuration it is provided that the firing aid has a chemical/physical and/or thermal and/or electrical and/or dielectric property comparable with the firing object.

In accordance with one advantageous configuration it is provided that the firing aid is embodied in the form of balls and/or granules and/or a parallelepiped and/or a plate and/or a powder.

In accordance with one advantageous configuration it is provided that the firing aid is embodied in at least two layers.

In accordance with one advantageous configuration it is provided that a disc transparent to the wavelength of the measurement signal is arranged between the firing aid and the optical temperature detection element.

In accordance with one advantageous configuration it is provided that the disc is situated on a top side and/or side wall of the firing chamber and/or on the firing chamber base.

In accordance with one advantageous configuration it is provided that the optical temperature detection element is situated on the top side and/or side wall of the firing chamber and/or on the firing chamber base.

In accordance with one advantageous configuration it is provided that the optical temperature detection element is connected to a control unit of the furnace.

In accordance with one advantageous configuration it is provided that the optical temperature detection element is formed by a pyrometer.

In accordance with one advantageous configuration it is provided that at least one part of the firing aid and/or at least one part of the firing object is situated within the entire measurement spot of the pyrometer.

In accordance with one advantageous configuration it is provided that the heating device is a conventional gas or electrical heating system.

In accordance with one advantageous configuration it is provided that the heating device is an inductive heating system or a microwave heating system.

In accordance with one advantageous configuration it is provided that the firing chamber is vertically displaceable and/or pivotable relative to the fixedly arranged firing chamber base.

In accordance with one advantageous configuration it is provided that the firing chamber base is vertically displaceable and/or pivotable and/or rotatable relative to the fixedly arranged firing chamber.

Further advantages, details and features will become apparent from the description below of two exemplary embodiments.

### BRIEF DESCRIPTION OF THE FIGURES

FIG. 1 shows an embodiment of a furnace according to the invention with a contactless sensor, in a schematic illustration.

FIG. 2 shows schematically a modified embodiment of a furnace according to the invention.

### DETAILED DESCRIPTION

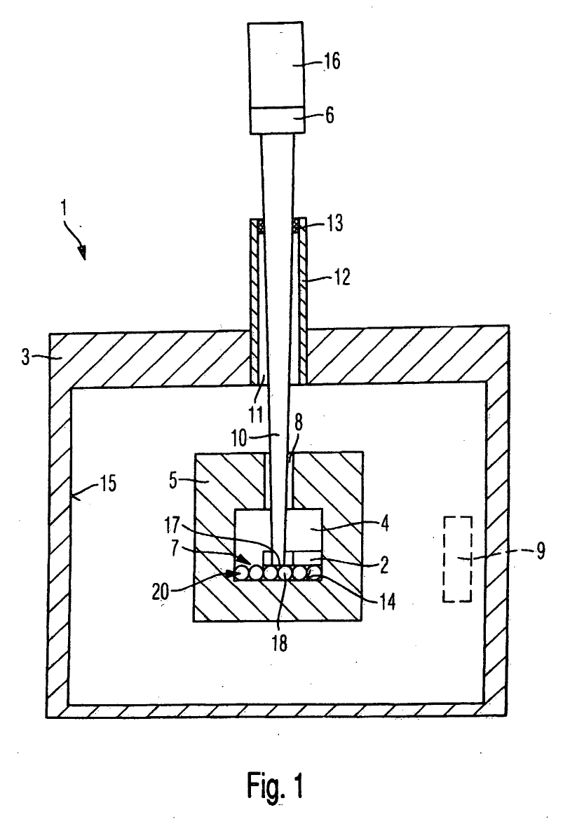

FIG. 1 shows a furnace 1 for the thermal treatment of at least one dental firing object 2. The furnace 1 can be embodied as an inductively heated furnace 1. The latter can in principal also be operated with gas or be embodied with a resistance heating element or infrared emitter. In particular, however, the furnace 1 is a microwave-heated furnace 1 with a microwave heating device 9 (not shown in detail). This furnace is provided with a furnace enclosure having a housing 3 with a firing chamber 4. The firing chamber 4 is an inner furnace chamber with an inner cladding 5. The latter forms an insulation of the inner furnace chamber of a microwave furnace. The heating device 9 is shown only schematically in principal, said heating device being situated between the housing 3 and the inner cladding 5. The method of operation and arrangement of a microwave heating device 9 are sufficiently known and are therefore not explained in any further detail.

An optical temperature detection element 6 detects the temperature in the firing chamber 4 or the inner furnace chamber.

According to the invention, the firing object 2 is mounted or arranged alongside a firing aid 7 situated in the firing chamber 4. As an alternative or in addition, however, the firing aid can also be arranged on and/or in the firing chamber.

The optical temperature detection element 6 directly detects the temperature of the firing aid 7 and not necessarily the temperature of the actual firing object 2. The latter temperature is detected only indirectly. Since both objects have comparable properties, their temperatures are identical. This is because the firing aid 7 has thermal and/or electrical and/or dielectric properties comparable with the firing object 2.

As is shown in FIG. 1, the firing aid 7 has the form of balls. However, granules, a plate, a parallelepiped or a powder can also be used. Although FIG. 1 shows only one layer of balls, the firing object 2 can, however, also be embodied in at least two layers.

The inner furnace chamber or the firing chamber 4 has an opening or hole 8 at its cladding 5 in order that a beam. 10 from the temperature detection element 6 can penetrate through the cladding 5. The outer housing 3 is likewise provided with a light-or radiation-transmissive opening 11, at which a tubular flange 12 is situated, which projects outward from the housing 3 in the direction of the temperature detection element 6.

A temperature-resistant disc 13 transparent to the radiation to be measured is arranged between the firing aid 7 and the optical temperature detection element 6. Said disc is composed of quartz glass, in particular, and serves as a termination of the flange 12. The quartz glass disc 13 is situated on a top side of the housing 3 or indirectly on the top side of the firing chamber 4. However, it can also be arranged indirectly or directly on the side wall of the firing chamber 4 and/or on the firing chamber base 14.

The optical temperature detection element 6 is positioned on the top side of the housing 3 or on the top side of the firing chamber 4. An arrangement on a side wall of the firing chamber or on the firing chamber base 14 is possible.

In order to make it possible to control the temperature of the dental firing object 2, the optical temperature detection element 6 is connected to an electrical control unit (not shown) of the furnace 1. This may be a two-point control which switches on the microwave heating system when a first threshold value is undershot, and switches off said heating system when a second, upper threshold value is exceeded. However, other temperature controls, e.g. PI controllers or PID controllers or fuzzy controllers, are also possible.

FIG. 1 shows the measuring head 16 of the contactless optical sensor for temperature detection. The optical temperature detection element 6 is preferably formed by a pyrometer. As illustrated in FIG. 1, at least one part of the firing aid 7 is situated within the entire measurement spot 17 of the pyrometer, which here detects approximately two balls. It is also possible for the measurement spot also to detect a part of the firing object 2. The measurement spot would correspondingly be larger.

Although it is not shown it is nevertheless possible for the firing chamber 4 to be vertically displaceable and/or pivotable relative to the fixedly arranged firing chamber base 14 or for the firing chamber base 14 to be vertically displaceable relative to the fixedly arranged firing chamber 4.

This preferred embodiment of the microwave furnace 1 according to the invention with the optical temperature detection element 6 and the firing aid 7 has the advantage that the firing aid 7 supplies a reliable temperature for the open-loop or closed-loop control of the firing process.

The preferred use of the furnace 1 is a thermal sintering treatment.

What is achieved by the described measurement principle in the microwave furnace 1 is that the temperature is measured optically. Thermoelements, which can only be used to a limited extent on account of their measurement position, intrinsic heating and antenna effect in the case of microwave furnaces, are thus avoided.

It should be taken into consideration that the optical temperature measurement described is a surface measurement. Measurement is effected on that area of the object at which the sensor is aimed. The object to be measured normally lies in this optical axis.

A user, for example a dental technician, does not have to precisely position a dental object or the firing object 2 for correct temperature control to be possible. This complexity and this source of errors are obviated by the invention.

Problems in orienting the dental object or the firing object 2 are avoided by means of the invention.

Moreover, measurement problems with regard to the lack of a uniform or planar surface of the dental object 2 are solved.

In addition, the firing object 2 is prevented from no longer being in focus during a sintering, to be precise owing to a sintering shrinkage.

A plurality of firing objects 2 can readily be used.

Unfavorable forms of the firing object 2, such as a horseshoe form, are non critical. In the case of direct measurement of the temperature on the object 2, the latter could not be positioned. The embodiment of the furnace 1 shown therefore obviates exact positioning of the firing object or objects 2 in the measurement region of the optical measurement system described. The parts to be sintered or the firing objects 2 can be placed onto the ball bed 18 created by the balls as firing aid 7, which have a temperature which is similar to the objects and which is sufficiently exact for the temperature measurement. The temperature of the balls 20 of the ball bed 18 is detected in the measurement spot 17.

The ball bed 18 is preferably composed of the same material as the firing objects themselves. However, said bed can also be a different material or a mixed material. Any other form is also possible instead of balls.

The advantage of the ball bed solution, moreover, is that in addition to simple mounting of the dental parts or of the firing objects 2, a homogenization of the temperature and a reduction of a temperature gradient are also achieved and a warpage of the parts is thus prevented. It is also advantageous that the ball bed 18 always has a constant mass.

The balls are arranged in at least two layers.

The firing aid 7 created by balls 20 interacts with the optical sensor of the temperature detection element 6 instead of a dental restoration part. Said firing aid 7 can be situated below and/or laterally with respect to the dental restoration part that is to be subjected to thermal treatment. It is expedient if the balls 20 have thermal and/or electrical and/or dielectric properties comparable with the dental restoration part in order that they can assume the same temperature as the dental restoration part or parts.

The firing aid 7 formed from balls, granules or powder is arranged in an open tank, for example. The dental restoration part or the firing object 2 can bear on the firing aid 7 or be at least partially or wholly embedded in said firing aid.

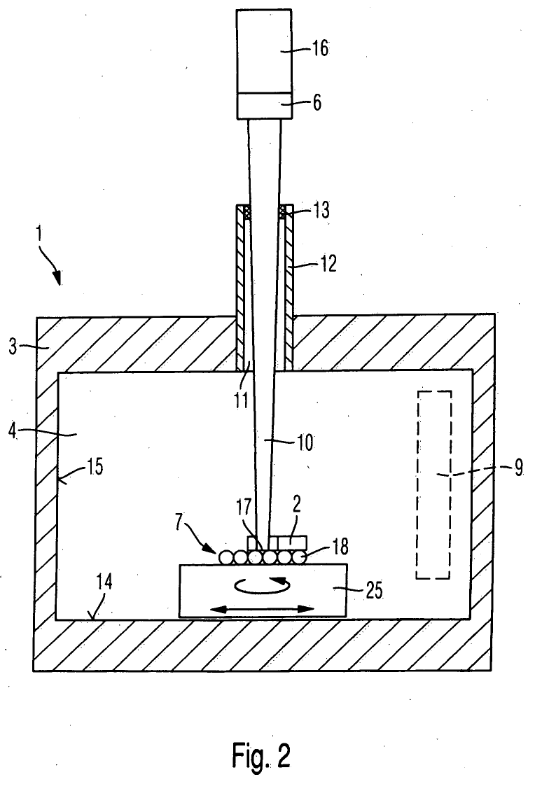

No inner enclosure is provided in the embodiment of FIG. 2. Identical reference symbols here relate to the same parts as in FIG. 1. In a departure from FIG. 1, in this embodiment a receptacle 25 is provided, which is preferably translationally displaceable, but also rotatable, in order to ensure optimum positioning.

The invention is not restricted to this example; thus, the sensor need not necessarily be an optical sensor. Other contactless sensors are also possible, for example IR sensors or thermopiles. The arrangement of the sensor can also deviate from the arrangement shown. Although the invention serves primarily for the sintering of dental objects, other applications are also possible.

Individual features described or shown can also be combined with one another as desired.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the terms as used in the claims are intended to include not only the designs illustrated in the drawings of this application and the equivalent designs discussed in the text, but are also intended to cover other equivalents now known to those skilled in the art, or those equivalents which may become known to those skilled in the art in the future.

What is claimed is:

1. A furnace (1) for the thermal treatment of at least one dental firing object (2) comprising a housing (3), a firing chamber (4), a firing chamber base (14), a heating device (9) and at least one optical temperature detection element (6) which can be used to detect a temperature in the firing chamber (4), wherein the firing object (2) is mounted on and/or in and/or below and/or alongside a firing aid (7) situated in the firing chamber (4), and the optical temperature detection element (6) detects the temperature of the firing aid (7) and/or of the firing object (2).

2. The furnace as claimed in claim 1, wherein the firing aid (7) has a chemical/physical and/or thermal and/or electrical and/or dielectric property comparable with the firing object (2).

3. The furnace as claimed in claim 1, wherein the firing aid (7) is embodied in the form of balls and/or granules and/or a parallelepiped and/or a plate and/or a powder.

4. The furnace as claimed in claim 1, wherein a disc (13) transparent to the wavelength of the measurement signal is arranged between the firing aid (7) and the optical temperature detection element (6).

5. The furnace as claimed in claim 4, wherein the disc (13) is situated on a top side and/or side wall of the firing chamber (4) and/or on the firing chamber base (14).

6. The furnace as claimed in claim 1, wherein the optical temperature detection element (6) is situated on the top side and/or side wall of the firing chamber (4) and/or on the firing chamber base (14).

7. The furnace as claimed in claim 1, wherein the furnace includes a control units, and wherein the optical temperature detection element (6) is connected to the control unit of the furnace (1).

8. The furnace as claimed in claim 1, wherein the optical temperature detection element (6) is formed by a pyrometer.

9. The furnace as claimed in claim 8, wherein at least one part of the firing aid (7) and/or at least one part of the firing object (2) is situated within the entire measurement spot of the pyrometer.

10. The furnace as claimed in claim 1, wherein the heating device (9) is a conventional gas or electrical heating system.

11. The furnace as claimed in claim 1, wherein the heating device (9) is an inductive heating system or a microwave heating system.

12. The furnace as claimed in claim 1, wherein the firing chamber (4) is vertically displaceable and/or pivotable relative to the fixedly arranged firing chamber base (14).

13. The furnace as claimed in claim 1, wherein the firing chamber base (14) is vertically displaceable and/or pivotable and/or rotatable relative to the fixedly arranged firing chamber (4).

14. A method for thermal treatment, in particular for sintering of a dental firing object (2), by means of a furnace (1) as claimed in claim 1.
